(19) United States
(12) Patent Application Publication
(10) Pub. No.: US 2005/0172474 A1
(43) Pub. Date: Aug. 11, 2005

(54) Method for the ceation of clearance holes

(76) Inventor: Massimo Criacci, Roma (IT)

Correspondence Address: BREINER & BREINER, 115 NORTH HENRY STREET, P. O. BOX 19290, ALEXANDRIA, VA, 22314, US

(21) Appl. No.: 10/505,430

(22) PCT Filed: Mar. 7, 2003
(86) PCT No.: PCT/IT03/00140

(30) Foreign Application Priority Data
Mar. 22, 2002 (IT) RM 02 A 000160

(51) Int. Cl. B23P 11/00

(52) U.S. Cl. 29/525.11

(57) ABSTRACT

According to this invention, slots are made on the plane of any material; the depth of these slots is equal to half the thickness of the plane, plus the length of the radius of the stay bolt or stud to be entered, plus a tolerance margin; the slots have the required length and are made on two or more sides of the plane, in an alternate manner, so that the slot made on one side overlaps by a few millimeters the slot made on the opposite side, creating in such a way the space for the passage of a stay bolt and stud that serves as the anchorage for the various pieces that make up to object to be realized.

### TECHNICAL FIELD

This invention related to a method to join together even different materials through the creation of clearance holes allowing the entry of stay bolts.

### BACKGROUND OF ART

It is common knowledge that the creation of a number of objects quite often entails the recourse to junctions by means of tongue and groove joint pins, eccentric joint pins, and L-shaped elements, made of metal and other materials, adhesives, and so on.

The solutions outlined above have been adopted worldwide since time immemorial, even though they are often inadequate from an aesthetic point of view and, sometimes, they offer a poor resistance, particularly to transverse stresses.

Besides, these solutions do not allow a great freedom of junction among the parts, particularly when one wants to join together parts with angles other than right angles.

### FUNDAMENTALS OF INVENTION

The subject of this invention is a method to join together even different materials through the creation of clearance holes allowing the entry of stay bolts.

According to this invention, slots are made on the plane of any material. The depth of these slots is equal to half the thickness of the plane, plus the length of the radius of the stay bolt or stud to be entered, plus a tolerance margin.

The slots have the required length and are made on two or more sides of the plane, in an alternate manner, so that the slot made on one side overlaps by a few millimeters the slot made on the opposite side, creating in such a way the space for the passage of a stay bolt and stud that serves as the—anchorage for the various pieces that make up to object to be realized.

Therefore, according to the method concisely described above, one may create seats of unlimited length for the passage of stay bolts or studs, while the thickness of the piece were the slots are made is determined exclusively by the depth that the tool being used may reach.

The detailed description provided below may allow an improved understanding of what has been briefly said until now by making reference to the attached drawings, where:

### BRIEF DESCRIPTION OF THE DRAWINGS

FIG. 1 shows the front view of a rectangular element worked according to the method of this invention.

FIG. 2 shows a schematic view of how the slots are made on both sides of the part.

FIG. 3 shows a cross section of a slot made according to this invention.

FIG. 4 shows an axonometric view of a part worked according to this invention.

FIG. 5 shows a section axonometric of a part worked according to this invention.

FIG. 6 shows an axonometric view of a part worked on an angle according to this invention.

FIG. 7 shows a section axonometric of a part worked on an angle according to this invention.

FIG. 8 shows a side view of a bookcase realized with a part worked according to this invention.

FIG. 9 shows a front view of the bookcase referred to in FIG. 8.

FIG. 10 shows a front section view of the bookcase referred to in FIG. 8.

FIG. 11 shows a top view of the bookcase referred to in FIG. 8.

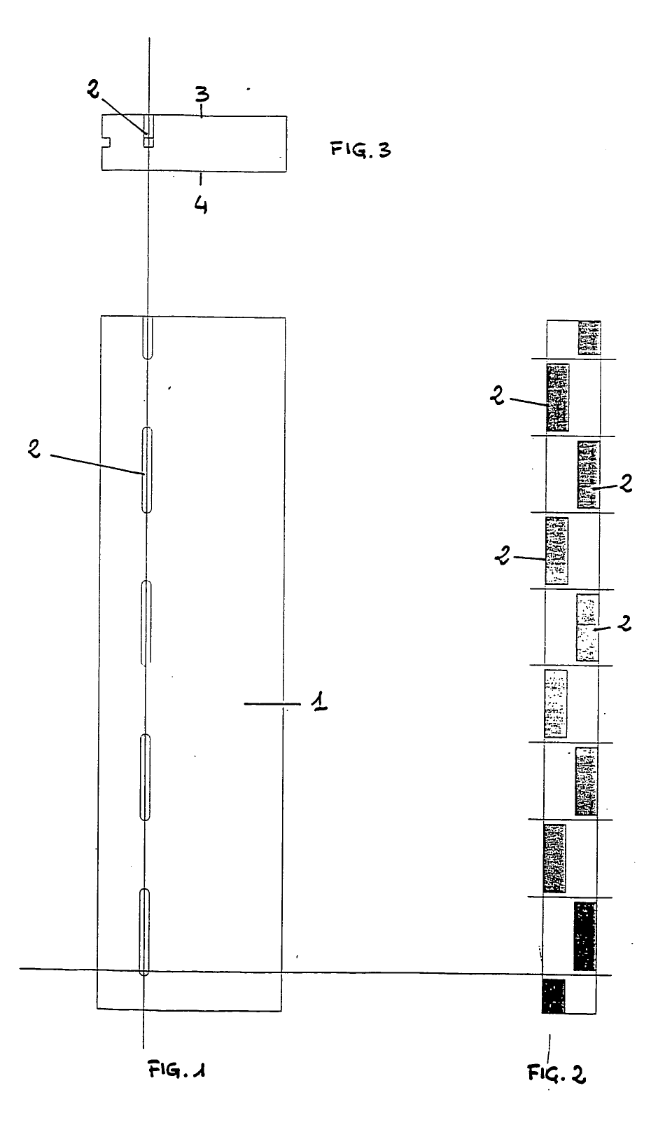

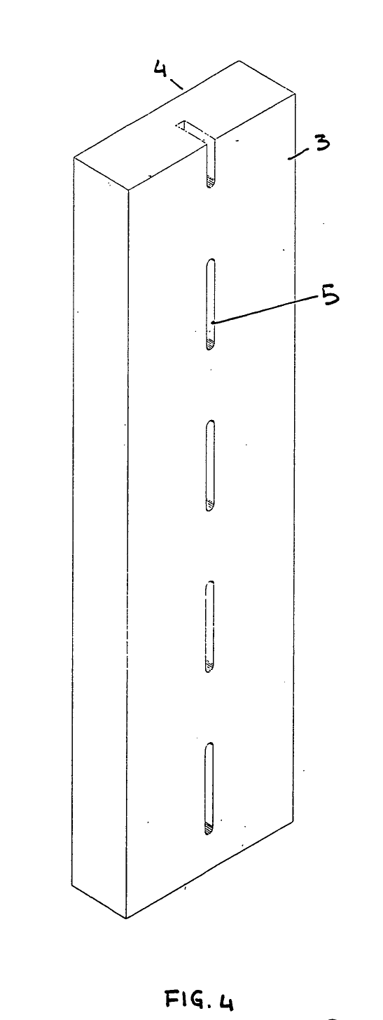

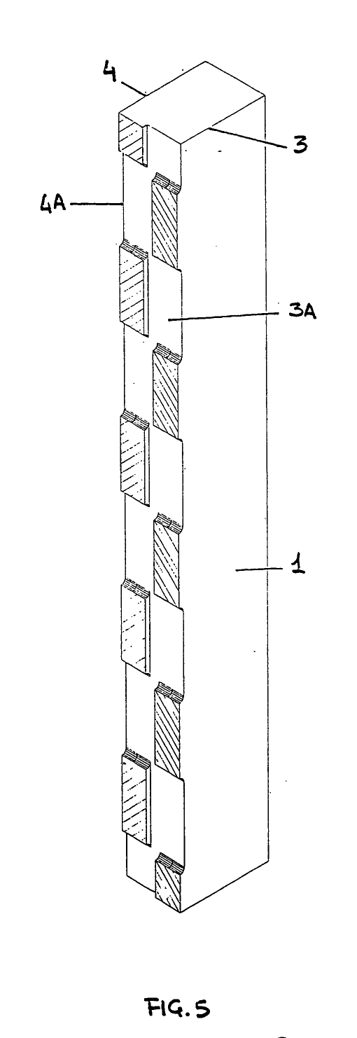

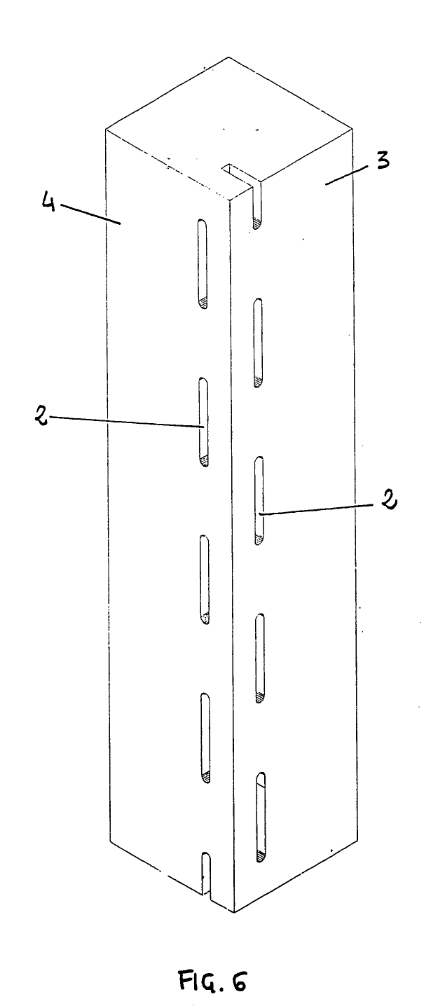

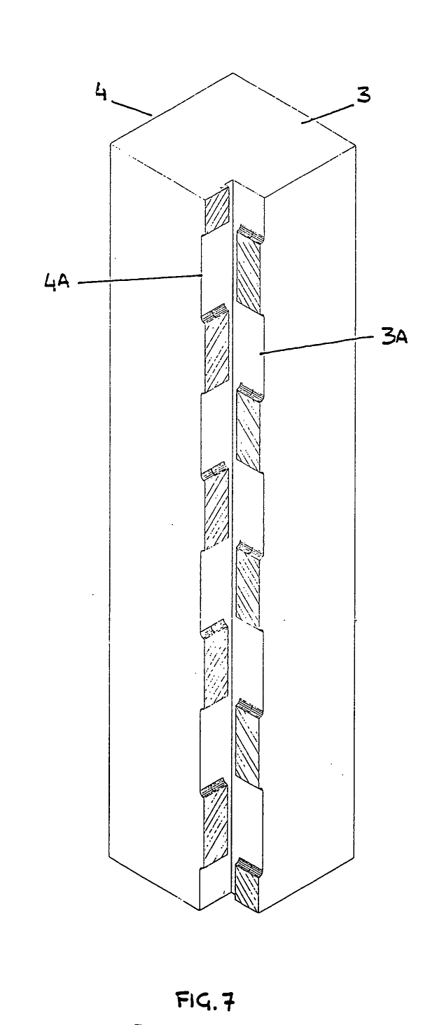

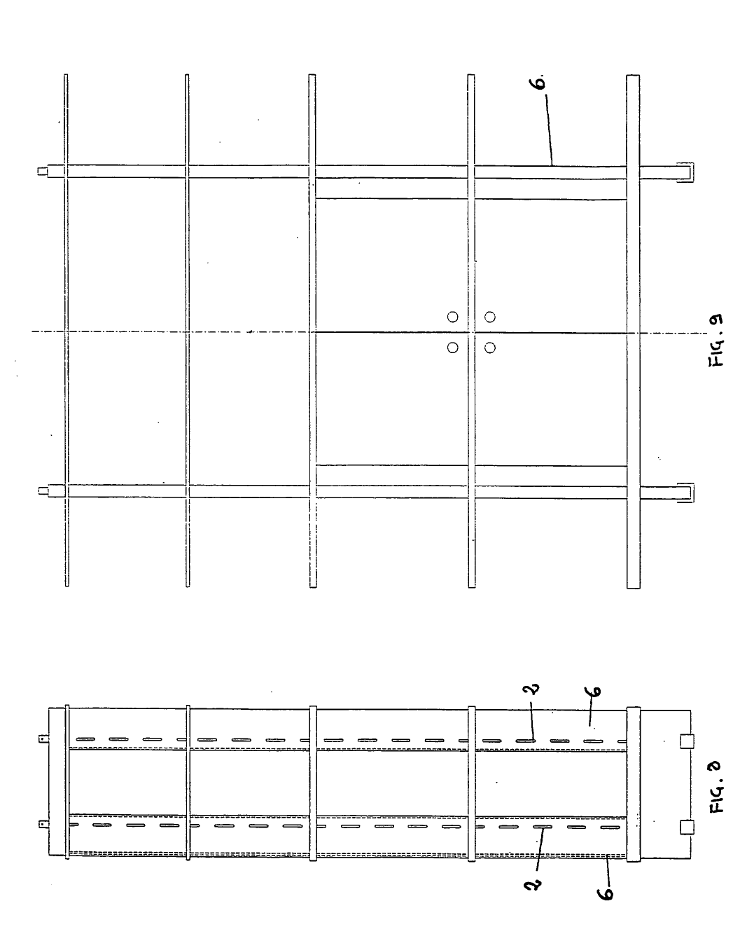

### DESCRIPTION OF INVENTION

With reference to these figures, the method for creating clearance holes according to this invention is based on the realization, on two or more sides of an element (1), for instance a wooden standard to be used in a bookcase, of a series of slots (2) made alternatively in succession on side (2) and on the opposite side (4) of the element (1), along an axis, in such a way as to create a hole that is the result of the removal of material (3a), taken off from side (3) and the removal of material (4a) taken off from the opposite side (4) (FIGS. 5-7). The clearance hole has the required length and its diameter is determined by half the thickness of the part being worked, plus the radius of the stay bold or cable, plus the tolerance of the materials that varies in relation to the materials themselves.

The clearance hole(s) may be used in the assembly of the parts that make up a piece of furniture such as, for instance, in the realization of a bookcase for the passage of stay bolts that allow to make the side of the bookcase an integral part of the shelves, without having to resort to the traditional anchoring methods described above.

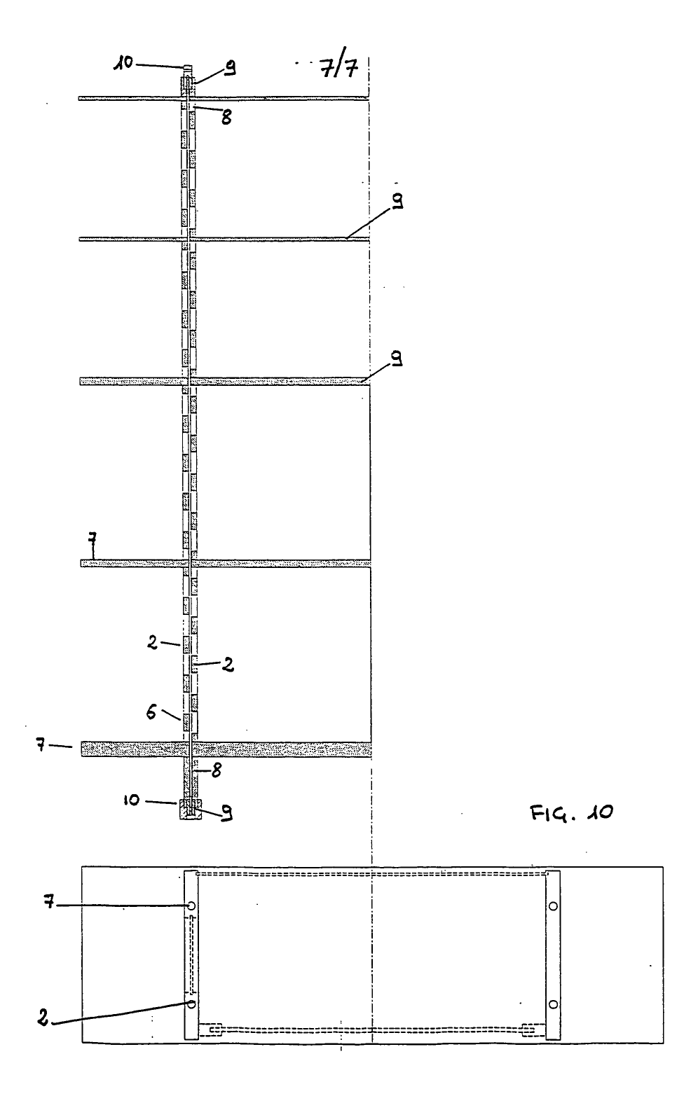

For instance, with reference to FIGS. 8, 9, 10, and 11, it may be easily understood how the realization of the bookcase being shown is extremely simplified by the presence along the standards (6) of the slots (2) that allow the passage of the stud (8).

The stud (8) allows the various sections of the standards (8) to form an integral part supporting the shelves (9) and to reach the required height even though, at least in the front part, nothing is visible.

Furthermore, the sturdiness of the system that is the subject matter of this invention is determined both by the fact that, being the stay bolts (8) accommodated inside the structure, they are protected from any impact, and the fact that their position may not change by chance depending on the stresses and size of the structure.

Obviously, in order to see that the stay bolts (8) carry out their function in the best possible manner, they shall be preferably provided with threaded ends for screwing terminals (10) which are to allow the adjustment of the tension of the stay bolts (8), even in relation to the material used to realize the object or, at least, the structure, but also in relation to the weight to be sustained and the use the object is intended for.

As previously pointed out. FIGS. 6 and 7 clearly show that a clearance hole may be created on an angle of the piece being worked, making slots (2) close to the angle always according to the arrangements described above.

In case of holes to be created in elements having a considerable width, for instance beams, the slots may be realized alternatively on each one of the four sides in such a way as to ensure the continuity in the material being removed and, therefore, the creation of the hole for the passage of the stud or reinforcement. A wooden beam for the falsework of a roof may represent an example of such an application.

It is clear that the possibility of creating clearance holes on the pieces to be assembled in order to accommodate cables or stay bolts of any type and material allows the greatest possible freedom in the realization, doing away with the design-related limitations that are currently imposed by the customary means of aggregation and assembly such as shelves, adhesives, tongue and groove joint pins, and so on.

The recourse to the aforementioned method, for instance, makes it both feasible and easy to realize an orientation in the assembly of the standard with respect to the shelf plane that is above or below 90, allowing in such a way the realization of bookcases or pieces of furniture where the design is not constrained by a right angle.

A further advantage that results from the application of the aforementioned method is that, being realizable on any material, including for instance Perspex, metal, wood and such artificial materials as plastics, it allows a joint to be made with no resulting problem due to the different materials being used.

It is evident that even though a likely application of the method was suggested with reference to the realization of a bookcase, this should not be construed as a limitation to the likely fields of use of this method as it was merely provided as an example.

1. Method for the creation of clearance holes on a part being worked (1), where there is a side (3) and a side (4) which are either opposite or adjacent, characterized by the fact that a series of slots (2) are alternatively made in succession and along an axis on the said sides (3) and (4) of the part (1), once on side (3) and once on side (4) of the said part, in such a way as to create a continuity between the material taken off for the realization of the slots (2) on side (3) and on side (4) and, in so doing, the removal of the material of the slots (2) forms a clearance hole at the centre of the thickness of the part on which the slots (2) have been made, and such a hole is useful for the passage of studs or cables.

2. Method for the creation of clearance holes, according to the preceding claim, characterized by the fact that the clearance hole has the required length, while the depth of the slot is determined by half the thickness of the part being worked, plus the radius of the stay bolt or cable, plus the tolerance of the materials, and varies in relation to the materials themselves.

3. Method for the creation of clearance holes, according to the preceding claims, characterized by the fact that, if the slots are created on adjacent sides of the part, it becomes feasible to make clearance holes located close to the angles.

4. Method for the creation of clearance holes, according to the preceding claims, characterized by the fact that the two ends of the stud or cable (8) that acts as a stay bolt and is accommodated within the clearance hole are threaded so that a terminal joining the parts crossed by such a stud or cable may be screwed on these ends.

5. Method for the creation of clearance holes, according to the preceding claims, characterized by the fact that the slots may be made on any material whatsoever, so that the method allows to join together parts that may also be made of different materials.
